(19) United States
(12) Patent Application Publication
(10) Pub. No.: US 2025/0016184 A1
(43) Pub. Date: Jan. 9, 2025

(54) METHOD AND APPARATUS FOR DETERMINING CLICK-FARMING IN LIVE ROOM

(71) Applicant: SHANGHAI BILIBILI TECHNOLOGY CO., LTD., Shanghai (CN)

(72) Inventor: Yuanyuan SUN, Shanghai (CN)

(21) Appl. No.: 18/706,587

(22) PCT Filed: Jun. 17, 2022
(86) PCT No.: PCT/CN2022/099477

§ 371 Date: May 1, 2024

(30) Foreign Application Priority Data
Nov. 2, 2021 (CN) 202111290640.7

(51) Int. Cl. H04L 9/40; H04N 21/2187

(52) U.S. Cl. CPC H04L 63/1425; H04N 21/2187

(57) ABSTRACT

This application provides a method and an apparatus for determining click-farming in a live room. The method for determining click-farming in a live room includes: collecting statistics on historical information about terminal devices which accessed a livestreaming platform, and determining a historical terminal ratio; collecting current information about terminal devices accessing a target live room, and determining a current terminal ratio based on the current terminal information; and determining, whether click-farming exists in the target live room based on the historical terminal ratio and the current terminal ratio. According to this method, statistics on information about terminal devices used by viewers is collected. It is determined whether click-farming exists in the live room by comparing the terminal information with a historical record. This enriches means for determining click-farming in the live room, and effectively improves accuracy of determining click-farming.

This application claims priority to Chinese Patent Application No. 202111290640.7, filed with the China National Intellectual Property Administration on Nov. 2, 2021, and entitled “METHOD AND APPARATUS FOR DETERMINING CLICK-FARMING IN LIVE ROOM”, which is incorporated herein by reference in its entirety.

### TECHNICAL FIELD

This application relates to the field of network livestreaming technologies, and in particular, to a method for determining click-farming in a live room. This application also relates to an apparatus for determining click-farming in a live room, a computing device, a computer-readable storage medium, and a computer program.

### BACKGROUND

With improvement of a network communication technology and acceleration of a broadband network, livestreaming has seen greater development and application. In an existing livestreaming system, popularity is an important indicator for ranking rooms of a livestreaming platform. Usually, higher popularity indicates a higher ranking and a higher possibility that an online streamer is watched by a user. A real-time quantity of viewers in a live room is a key part in popularity calculation. Consequently, to improve popularity, some online streamers use illegal means to simulate viewing of live rooms, and forge quantities of online viewers in the live rooms, that is, improve popularity rankings through click-farming. Therefore, how to accurately determine whether click-farming exists in a live room is an important means to maintain ecological stability of a livestreaming platform.

Currently, it is determined whether click-farming exists in the live room by determining whether there is a steep increase or a jitter in a total person quantity of the live room. This determining method is single, and an error in determining sometimes occurs.

### SUMMARY

In view of this, an embodiment of this application provides a method for determining click-farming in a live room. This application also relates to an apparatus for determining click-farming in a live room, a computing device, a computer-readable storage medium, and a computer program, to resolve a problem in the conventional technology that a method for determining whether click-farming exists in a live room is single, and accuracy is relatively low.

According to a first aspect of the embodiments of this application, a method for determining click-farming in a live room is provided and includes:
collecting statistics on historical terminal information of a livestreaming platform, and determining a historical terminal ratio;
collecting current terminal information of a target live room, and determining a current terminal ratio based on the current terminal information; and
determining, according to the historical terminal ratio and the current terminal ratio, whether click-farming exists in the target live room.

According to a second aspect of the embodiments of this application, an apparatus for determining click-farming in a live room is provided and includes:
a statistics collection means, configured to collect statistics on historical terminal information of a livestreaming platform, and determine a historical terminal ratio;
a collection means, configured to collect current terminal information of a target live room, and determine a current terminal ratio based on the current terminal information; and
a determining means, configured to determine, according to the historical terminal ratio and the current terminal ratio, whether click-farming exists in the target live room.

According to a third aspect of the embodiments of this application, a computing device is provided and includes a memory, a processor, and computer instructions stored in the memory and capable of being run on the processor. The processor executes the computer instructions to implement the steps of the method for determining click-farming in a live room.

According to a fourth aspect of the embodiments of this application, a computer-readable storage medium is provided and stores computer instructions. The computer instructions are executed by a processor to implement the steps of the method for determining click-farming in a live room.

According to a fifth aspect of the embodiments of this application, a computer program is provided. When the computer program is executed on a computer, the computer is enabled to perform steps of the method for determining click-farming in a live room.

The method for determining click-farming in a live room provided in this application includes: collecting statistics on historical terminal information of a livestreaming platform, and determining a historical terminal ratio; collecting current terminal information of a target live room, and determining a current terminal ratio based on the current terminal information; and determining, according to the historical terminal ratio and the current terminal ratio, whether click-farming exists in the target live room. In this embodiment of this application, statistics on information about a terminal used by a viewer is collected. It is determined, by comparing the terminal information with a historical record, whether click-farming exists in the live room. This enriches means for determining click-farming in the live room, and effectively improves accuracy of determining click-farming.

### BRIEF DESCRIPTION OF DRAWINGS

FIG. 1 is a flowchart of a method for determining click-farming in a live room according to a first embodiment of this application;

FIG. 2a and FIG. 2b are schematic statistical diagrams of a preset time duration of a type of live room according to a first embodiment of this application;

FIG. 3 is a processing flowchart of a method for determining click-farming in a live room according to a second embodiment of this application;

FIG. 4 is a processing flowchart of a method for determining click-farming in a live room according to a third embodiment of this application;

FIG. 5 is a schematic diagram of a structure of an apparatus for determining click-farming in a live room according to an embodiment of this application; and

FIG. 6 is a block diagram of a structure of a computing device according to an embodiment of this application.

### DESCRIPTION OF EMBODIMENTS

Many specific details are described in the following description to facilitate full understanding of this application. However, this application can be implemented in many other manners different from those described herein, and a person skilled in the art can make similar promotion without departing from the connotation of this application. Therefore, this application is not limited by specific implementations disclosed below.

Terms used in one or more embodiments of this application are merely for the purpose of describing a specific embodiment, and are not intended to limit the one or more embodiments of this application. The terms “a”, “the”, and “said” of singular forms used in one or more embodiments and the appended claims of this application are also intended to include plural forms, unless otherwise specified in the context clearly. It should be further understood that the term “and/or” used in one or more embodiments of this application indicates and includes any or all possible combinations of one or more associated listed items.

It should be understood that although terms such as “first” and “second” can be used in one or more embodiments of this application to describe various types of information, the information is not limited to these terms. These terms are only used to distinguish between information of the same type. For example, without departing from the scope of one or more embodiments of this application, “first” may also be referred to as “second”, and similarly, “second” may also be referred to as “first”. Depending on the context, for example, the word “if” used herein can be interpreted as “while”, “when”, or “in response to determining”.

Terms used in one or more embodiments of this application are explained first.

Live popularity: refers to a value calculated based on a specific ratio by integrating a quantity of viewers, a quantity of bullet-screen comments, a quantity of gifts, and the like. The live popularity is used for ranking based on popularity at a livestreaming platform.

Quantity of livestreaming viewers: is a real quantity of persons viewing a live room in real time.

Click-farming: refers to a case in which a large amount of false viewing is generated by simulating normal user access, that is, simulating viewing of a live room by using an illegal means.

Terminal: refers to a device used when a user views livestreaming, for example, a desktop computer, a mobile phone, or a tablet computer.

Terminal system: is an operating system corresponding to a terminal.

In an existing livestreaming system, a person quantity is usually counted in a manner of periodically reporting a heartbeat by a client player. When it is determined whether click-farming exists in a live room, a total person quantity of the live room is usually calculated, and it is determined whether there is a steep increase or decrease in the total person quantity. Usually, a person quantity of a room increases gradually, and the person quantity shows a curve rise. Usually, click-farming cannot be accurately controlled in a live room in which click-farming exists, and there is a steep increase in a person quantity at a moment, for example, the person quantity increases from 200 to 3,000 in 2 minutes. However, it is not accurate enough to determine whether click-farming exists based on the total person quantity. If control in the live room in which click-farming exists is accurate enough, an effect of slowly increasing in the total person quantity can be simulated. Therefore, it is not accurate enough to determine by using only the total person quantity.

Based on this, this application provides a method for determining click-farming in a live room. This application also relates to an apparatus for determining click-farming in a live room, a computing device, and a computer-readable storage medium. The method for determining click-farming in a live room, the apparatus for determining click-farming in a live room, the computing device, and the computer-readable storage medium are described in detail in the following embodiments one by one.

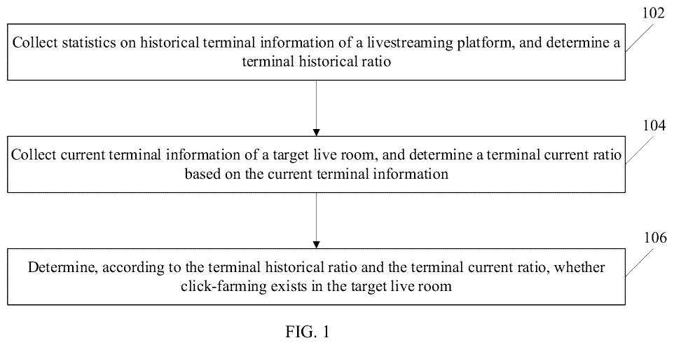

FIG. 1 is a flowchart of a method for determining click-farming in a live room according to an embodiment of this application. The method specifically includes the following steps:

Step 102: Collect statistics on historical terminal information of a livestreaming platform, and determine a historical terminal ratio.

The livestreaming platform is a platform providing various livestreaming for a user. An online streamer creates a live room on the livestreaming platform for livestreaming. The user may enter a live room by using the livestreaming platform for viewing livestreaming. In actual application, the user needs to use a terminal device to enter the live room, for example, a mobile phone, a tablet computer, and a notebook computer. When the user logs in to the livestreaming platform, the livestreaming platform obtains information about a terminal used by the user. For example, a user A enters the live room by using a mobile phone terminal, and a user B logs in to a computer and enters the live room by using a browser.

The historical terminal information specifically is terminal information of terminal devices which accessed the livestreaming platform in a past period of time, for example, information about terminal devices used to view livestreaming within past 24 hours.

The historical terminal ratio specifically is a ratio of terminal devices obtained after classification after the historical terminal information is obtained and the terminal devices are classified based on a subsequent processing rule. For example, after statistics on the historical terminal information is collected, classification is performed according to a historical terminal type, including a web terminal and a mobile terminal, and in this case, the historical terminal ratio is the web terminal(s):the mobile terminal(s). If the terminal devices are classified into a web terminal type, an IOS terminal type, and an Android terminal type according to the historical types of terminal devices, the historical terminal ratio is web:IOS:Android.

In actual application, a specific form of the historical terminal ratio is not limited, which is subject to actual application. For ease of explanation, in a first embodiment provided in this application, that the terminal devices are classified into a web terminal and a mobile terminal according to a terminal type is used as an example for explanation and description. In the first embodiment provided in this application, the step of collecting statistics on historical terminal information of a livestreaming platform, and determining a historical terminal ratio includes:
determining a live room type on the livestreaming platform;
collecting statistics on historical terminal information corresponding to each live room type; and
calculating a historical terminal ratio corresponding to each live room type according to the historical terminal information corresponding to each live room type.

The live room type specifically is a specific type of livestreaming in the live room, for example, a large-scale online game, a mobile game, entertainment tried singing, and a radio station (livestreaming audio only). Different types of live rooms have different livestreaming statuses, which further affects distribution of terminal devices. For example, in a large-scale online game type, a game is mostly on a PC terminal, and a livestreaming picture occupies an entire computer screen. If a user views by using a mobile terminal, because a screen of the mobile terminal device is relatively small, picture quality is compressed, a picture is relatively small, and details cannot be clearly viewed. Therefore, most users view by using web terminal devices (PC terminal devices), to obtain optimal viewing experience. For another example, for livestreaming of an entertainment tried singing type, a male/female online streamer mostly sings, chats, or the like. There is often only one person on a picture, and livestreaming is usually performed by using a mobile phone. If a user views by using a web terminal, a screen is relatively large, and only one person is displayed on the entire screen, which also affects experience. If the user views by using a mobile phone, the picture is exactly displayed completely on a screen of the mobile phone. Therefore, for entertainment tried singing, viewing users focus on mobile phone terminal devices. Therefore, different live room types have different terminal distribution. Before statistics on the terminal information is collected, the live room types on the livestreaming platform are classified.

After the live room type is determined, statistics on the historical terminal information corresponding to each live room type is collected. For example, for a live room of a game type, viewing livestreaming using web terminal devices has a relatively high ratio, and for a live room of an entertainment type, viewing livestreaming on mobile phone terminal devices has a relatively high ratio. After classification is performed on the live room, statistics on the terminal information of the live room type is collected.

In actual application, even in a same type of live room, distribution of terminal devices may be different in different time periods. For example, a ratio of using mobile phone terminal devices is relatively high in daytime because users work, and a ratio of using web terminal devices increases in the evening. When it is close to the early morning, a ratio of mobile phone terminal devices increases again because sleep is needed. Therefore, statistics on terminal information of different live room types can also be collected by using a preset time duration. The preset time duration is a predetermined time, for example, past 24 hours and past 48 hours.

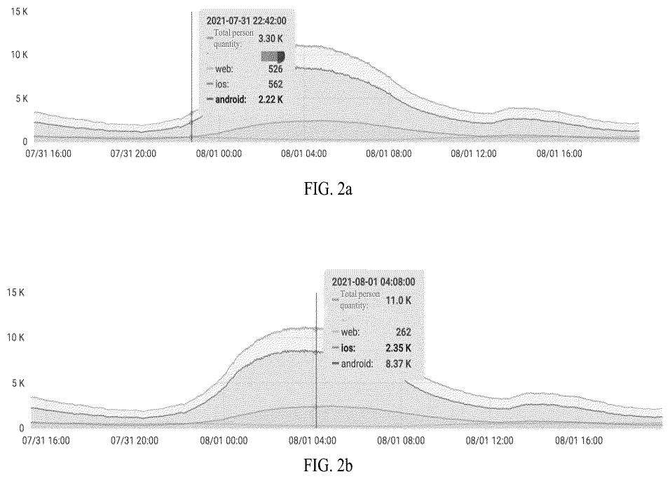

The preset time duration further includes at least one statistical period, and there are a plurality of statistical time points in each statistical period. The statistical time point is a time point at which terminal information is collected in the preset time duration, for example, collection is performed every 1 minute, or collection is performed every 5 minutes. Statistics on information about terminal devices used by viewers in all live rooms is collected at the statistical time point. The statistical period specifically is a time period used to collect statistics on terminal devices. Usually, one statistical period includes a plurality of statistical time points, and one preset time duration includes a plurality of statistical periods. For example, the preset time duration is past 24 hours, the past 24 hours are divided into 24 statistical periods in a unit of hour, and the terminal information is collected every 1 minute in each statistical period. FIG. 2 is a schematic statistical diagram of a preset time duration of a type of live room according to a first embodiment of this application. As shown in a in FIG. 2, at a statistical time point of an evening rush hour 22:42, a proportion of web terminal devices is 526/3300-16%. As shown in b in FIG. 2, at a statistical time point of 4:08 in the morning, a proportion of web terminal devices is 262/11000=2%.

After statistics on terminal percentage information at each statistical time point is collected, a maximum percentage of terminal devices and a minimum percentage of terminal devices in a statistical period may be determined, so that a proportion information duration of terminal devices is further determined. For example, for a type A of live room, in a statistical period at 0-1 o'clock, a maximum percentage of web terminal devices is 25% and a minimum percentage is 18%, and a maximum percentage of mobile terminal devices is 82% and a minimum percentage is 75%. In this case, for the type A of live room at 0-1 o'clock, a proportion information duration of the web terminal devices is “18%-25%”, and a proportion information duration of the mobile terminal devices is “75%-82%”.

Specifically, the collecting statistics on historical terminal information corresponding to each live room type includes:
obtaining a user set corresponding to each live room type; and
determining terminal information of terminal devices used by users in each user set.

In actual application, when statistics on the historical terminal information of each live room type is collected, the user set of each live room type needs to be determined first, and then a type of a terminal, for example, a web terminal or a mobile terminal, used by each user in the user set is separately obtained.

Step 104: Collect current terminal information of a target live room, and determine a current terminal ratio based on the current terminal information.

The target live room is a live room that needs to be determined whether click-farming exists. For example, if currently it is necessary to determine whether click-farming exists in a live room 1, the live room 1 is a target live room. If it is necessary to determine whether click-farming exists in a live room 2, the live room 2 is a target live room.

In actual application, after the foregoing step 102, overall data of the livestreaming platform can be obtained. In this case, it is necessary to determine whether click-farming exists in the target live room. Specifically, the current information of terminal devices accessing the target live room is obtained, that is, a total quantity of terminal devices accessing the target live room at a current time point and a quantity of each type of terminal device are obtained. Further, a current terminal ratio of each type of terminal device at the current time point is calculated according to the quantity of each type of terminal device and the total quantity of the terminal devices.

In actual application, a person quantity of each live room varies. If a person quantity of a live room is relatively small, and click-farming obviously does not exist, the live room does not need to be determined. Therefore, before the step of collecting current terminal information of a target live room, the method further includes:
determining an initial live room on the livestreaming platform, and obtaining a quantity users in the initial live room; and
when the quantity exceeds a preset threshold, determining the initial live room as a target live room.

Specifically, the initial live room is determined on the livestreaming platform, for determining whether livestreaming click-farming needs to be determined for the initial live room. After the initial live room is determined, the live room person quantity of the initial live room is obtained. When the live room person quantity exceeds the preset threshold, the initial live room is determined as the target live room. For example, for a live room, a quantity of viewers is only 10, and in this case, it is not necessary to determine whether click-farming exists in the live room. Because there is too little data, there is no global same attribute. The initial live room is determined only after the live room person quantity of the initial live room exceeds a specific quantity. By screening the live room person quantity, a live room with an insufficient person quantity can be filtered out, and there is no need to determine the live room with the insufficient person quantity, reducing calculation pressure of a server and effectively improving resource utilization.

In the first embodiment provided in this application, the step of collecting current terminal information of a target live room, and determining a current terminal ratio based on the current terminal information includes:
determining a target live room type of the target live room and current terminal information corresponding to the target live room; and
calculating current terminal percentage information of the target live room according to the current terminal information.

In the first embodiment provided in this application, the target live room type of the target live room is specifically determined, as for example, a game type and an entertainment singing-hop type. In addition, the current terminal information corresponding to the target live room needs to be determined, and then the current terminal percentage information of the target live room is calculated according to the current terminal information. For example, a current time point is 20:30. A total quantity of terminal devices of the target live room at 20:30 and a quantity of each type of terminal device are collected. Further, current terminal percentage information of the target live room at 20:30 is calculated according to the quantity of each type of terminal device and the total quantity of terminal devices.

Step 106: Determine, according to the historical terminal ratio and the current terminal ratio, whether click-farming exists in the target live room.

After the historical terminal ratio and the current terminal ratio are obtained, it may be determined, according to the two pieces of ratio information, whether click-farming exists in the target live room.

In the first embodiment provided in this application, the step of determining, according to the historical terminal ratio and the current terminal ratio, whether click-farming exists in the target live room includes:
determining a target historical terminal ratio according to the target live room type; and
when the current terminal percentage meets the target historical terminal ratio, determining that click-farming does not exist in the target live room; or
when the current terminal percentage does not meet the target historical terminal ratio, determining that click-farming exists in the target live room.

In the first embodiment, the target live room type of the target live room is to be determined. After the target live room type is determined, the target historical terminal ratio corresponding to the target live room type may be obtained from the historical terminal ratios. For example, the target live room type of the target live room is the entertainment tried singing type. For a live room of the entertainment tried singing type, the proportion information duration of the web terminals in the historical terminal ratio is “18%-25%”. The current terminal percentage information of the target live room is that proportion information of web terminals is 38%. In this case, the current terminal percentage information does not meet the target historical terminal ratio, and it can be determined that click-farming exists in the target live room.

In another specific implementation of the first embodiment, the target live room type of the target live room is the large-scale online game type, and the current terminal percentage information of the target live room is that terminal percentage information of web terminals is 56%. For a live room of the large-scale online game type, the proportion information duration of the web terminals in the historical terminal ratio is “40%-60%”. In this case, the current terminal percentage information meets the target historical terminal ratio, and it can be determined that click-farming does not exist in the target live room.

The method for determining click-farming in a live room provided in the first embodiment of this application includes: collecting statistics on historical terminal information of a livestreaming platform, and determining a historical terminal ratio; collecting current terminal information of a target live room, and determining a current terminal ratio based on the current terminal information; and determining, according to the historical terminal ratio and the current terminal ratio, whether click-farming exists in the target live room. A comprehensive analysis manner of combining the live room type with the terminal distribution is used to determine whether click-farming exists in the live room. An anti-click-farming policy of comprehensively determining the click-farming situation according to the historical terminal percentage information and the current terminal percentage information enriches methods for determining whether click-farming exists in the live room, and improves accuracy of determining click-farming.

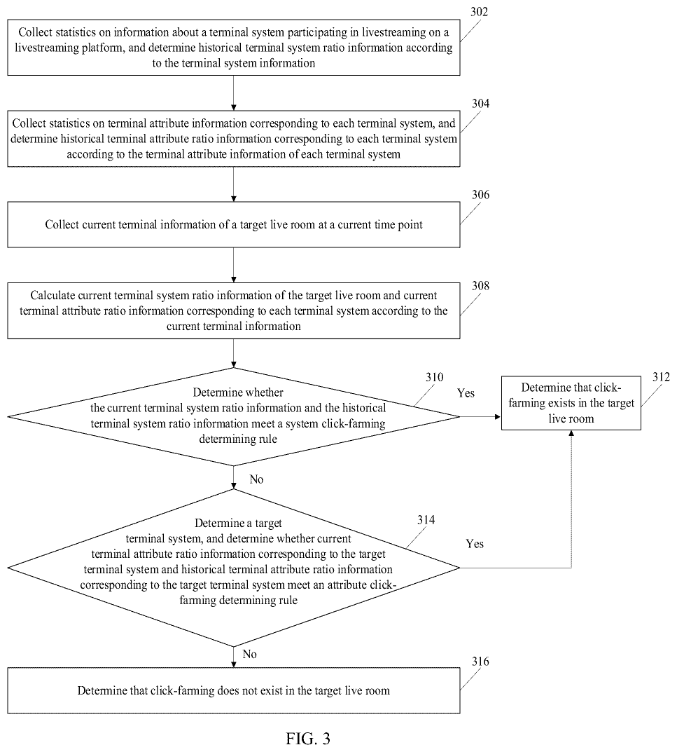

FIG. 3 is a schematic flowchart of a method for determining click-farming in a live room according to a second embodiment of this application. In actual application, for a more refined method for determining click-farming in a live room, it can be further combined with attribute information of a terminal to determine whether click-farming exists in a live room. The following steps may be specifically included.

Step 302: Collect statistics on information about a terminal system participating in livestreaming on the livestreaming platform, and determine historical terminal system ratio information according to the terminal system information.

The step of collecting statistics on information about a terminal system participating in livestreaming on the livestreaming platform includes:
obtaining a set of users participating in livestreaming on the livestreaming platform; and
determining terminal system information of terminal devices used by users in each user set.

The terminal system information is operating system information of a terminal used by a user, for example, a web terminal, an ios terminal, and an Android terminal. Statistics on a quantity corresponding to each operating system is separately collected, and then the historical terminal system ratio information is determined. In actual application, the set of users participating in livestreaming on the livestreaming platform is usually determined, and then terminal system information of a terminal used by each user in each user set is determined. For example, in past 24 hours, a total of 210,000 users participate in livestreaming. There are 30,000 users who use web terminal devices, there are 60,000 users who use ios terminal devices, and there are 120,000 users who use Android terminal devices. In this case, the historical terminal system ratio information is “web:Android:ios=1:4:2”.

Step 304: Collect statistics on terminal attribute information corresponding to each type of terminal device, and determining historical terminal attribute ratio information corresponding to each type of terminal device according to the terminal attribute information of each type of terminal device.

In actual application, because a mobile phone, a tablet computer, a browser, and the like of a user are not frequently changed (changed a plurality of times in one day). Based on this, it may be considered that a terminal used by the user does not change obviously in a short time. For example, if a brand used by a user a is a brand A, a model is 11, and a publication year is 2020, mobile phone system information of the user is marked as “brand A, model 11, 2020”. For another example, if a user b uses a web terminal, a brand of a browser is a brand C, a model is MO, and a publication year is 2019, web system information of the user is marked as “brand C, MO, 2019”.

In actual application, for the mobile phone, the tablet computer, and the browser, a brand and a model thereof are fixed, and a publication year is updated with upgrade of a manufacturer. Usually, an update period of the manufacturer is several months. Therefore, “brand+model+version number” may be used as a viewing identifier of a user, that is, terminal attribute information of a terminal used by the user.

In actual application, a client device periodically reports to a server in a heartbeat reporting form, and reports viewing information of a current user, including a room number, viewing time, information of a type of a terminal device (a web terminal, ios, or Android) used by the user, and terminal attribute information (brand+model+version number). After receiving heartbeat information, the server summarizes all the information, and determines the historical terminal attribute ratio information corresponding to each type of terminal device according to the terminal attribute information of each type of terminal device.

In an ios type of terminal device, there are three models: an ios-model A, an ios-model B, and an ios-model C. There are 10,000 persons using the ios-model A, there are 40,000 persons using the ios-model B, and there are 10,000 persons using the ios-model C. In this case, it can be determined that the historical terminal attribute ratio information is “model A:model B:model C=1:4:1” in this ios type of terminal device.

Step 306: Collect the current terminal information of the target live room at the current time point.

In the second embodiment provided in this application, terminal device information of the target live room is collected once every period of time (for example, 5 minutes). In actual application, to improve calculation efficiency, statistics on information about a user quantity of the target live room is further collected. If the user quantity of the target live room exceeds a preset threshold, it is determined whether click-farming behavior exists in the target live room. For example, it is collected that there are a total of 12,000 users in the target live room at the current time point. There are 4,000 users using web terminal devices, there are 6,000 users using Android systems, and there are 2,000 users using ios systems. There are five device models corresponding to the web terminal devices, there are eight device models corresponding to the Android systems, and there are three device models corresponding to the ios systems.

Step 308: Calculate current terminal system ratio information of the target live room and current terminal attribute ratio information corresponding to each terminal system according to the current terminal information.

According to the collected current terminal information, terminal system ratio information of the target live room at the current time point and corresponding terminal attribute ratio information of each terminal system may be calculated. For example, the foregoing example is still used. There are 4,000 users using the web terminal devices, there are 6,000 users using the Android systems, and there are 2,000 users using the ios systems. Therefore, the current terminal system ratio of the target live room is “web:Android:ios=2:3:1”. For the web terminal devices, there are five device models in total, and current terminal attribute ratio information corresponding to the web terminal devices is “web1:web2:web3:web4:web5=1:2:3:4:5”. For the Android systems, there are eight device models in total, and current terminal attribute ratio information corresponding to the Android systems is “Android1:Android2:Android3:Android4:Android5:Android6:Android7: Android8=1:2:3:4:5:6:7:8”. For the ios type of terminal device, there are three models in total, and current terminal attribute ratio information corresponding to the ios type is “iosA:iosB:iosC=1:2:3”

Step 310: Determine whether the current terminal system ratio information and the historical terminal system ratio information meet a system click-farming determining rule; and if yes, perform step 312, or if no, perform step 314.

After the current terminal system ratio information and the historical terminal system ratio information are obtained, it is first determined, according to the current terminal system ratio information and the historical terminal system ratio information, whether the click-farming behavior exists in the target live room. Specifically, any two elements in the current terminal system ratio information and the historical terminal system ratio information are selected for comparison. If a difference exceeds a system threshold, it is determined whether click-farming behavior exists in the target live room; otherwise, subsequent determining is further performed.

In the second embodiment provided in this specification, the current terminal type ratio is “web:Android:ios=2:3:1”, the historical terminal type ratio information is “web:Android:ios=1:4:2”, and the system threshold is 10%. In this case, if a difference between any two system ratios exceeds 10%, it is determined that the click-farming behavior exists. By using “web:ios” as an example, the current terminal system ratio information is “web:ios=2:1=2”, and the historical terminal type ratio information is “web:ios=1:2-0.5”. In this case, for “web:ios”, a difference between the current terminal system ratio information and the historical terminal type ratio information is “(the current terminal type ratio information−the historical terminal type ratio information)/the historical terminal type ratio information”, that is, (2−0.5)/0.5=300%, which far exceeds the threshold 10%. In this case, step 312 is performed.

If a difference between the current terminal system ratio information and the historical terminal type ratio information is less than the type threshold for any two terminal types, step 314 is performed.

Step 312: Determine that click-farming exists in the target live room.

For a target live room meeting a condition, it may be directly determined that click-farming exists in the target live room.

Step 314: Determine a target terminal type, and determine whether current terminal attribute ratio information corresponding to the target terminal type and historical terminal attribute ratio information corresponding to the target terminal type meet an attribute click-farming determining rule; and if yes, perform step 312, or if no, perform step 316.

In the second embodiment provided in this specification, if a difference between the current terminal type ratio information and the historical terminal type ratio information is less than the threshold for any two terminal types, it indicates that whether the click-farming behavior exists in the target live room cannot be directly determined based on the terminal type ratio information. In this case, further determining needs to be performed according to terminal attribute ratio information in each terminal type.

Based on this, in a plurality of terminal types, one target terminal type is determined, and it is determined whether current terminal attribute ratio information and historical terminal attribute ratio information that correspond to the target terminal type meet the attribute click-farming determining rule, that is, whether a difference between the two exceeds an attribute threshold. For a specific calculation rule, refer to the foregoing method for calculating the current terminal type ratio information and the historical terminal type ratio information. Details are not described herein again.

An ios type is used as an example, and current terminal attribute ratio information corresponding to the ios type is “iosA:iosB:iosC=1:2:3”, and historical terminal attribute ratio information is “iosA:iosB:iosC=1:4:1”. For example, for “iosA:iosB”, the current terminal attribute ratio information is 0.5, the historical terminal attribute ratio information is 0.25, and the attribute threshold is 8%. In this case, for “iosA:iosB”, a difference between the current terminal type ratio information and the historical terminal type ratio information is “(0.5-0.25)/0.25=100%”, which exceeds the threshold 8%. In this case, step 312 is performed.

For any two pieces of terminal attribute ratio information in any terminal type, if a difference between current terminal attribute ratio information and historical terminal attribute ratio information is less than the attribute threshold, step 316 is performed.

Step 316: Determine that click-farming does not exist in the target live room.

For a target live room in which for any two pieces of terminal attribute ratio information in any terminal type, a difference between current terminal attribute ratio information and historical terminal attribute ratio information is less than the attribute threshold, it may be determined that click-farming does not exist in the target live room.

According to the method for determining click-farming in a live room provided in the second embodiment of this application, it is first determined whether the terminal type ratio information meets the type threshold. When the terminal type ratio information meets the type threshold, it is refined to the terminal attribute ratio information of each terminal type to determine whether the terminal attribute ratio information meets the attribute threshold. Click-farming in the live room is comprehensively determined in a manner of combining the terminal type with the terminal attribute, further enriching methods for determining whether click-farming exists in the live room, and improving accuracy of determining click-farming.

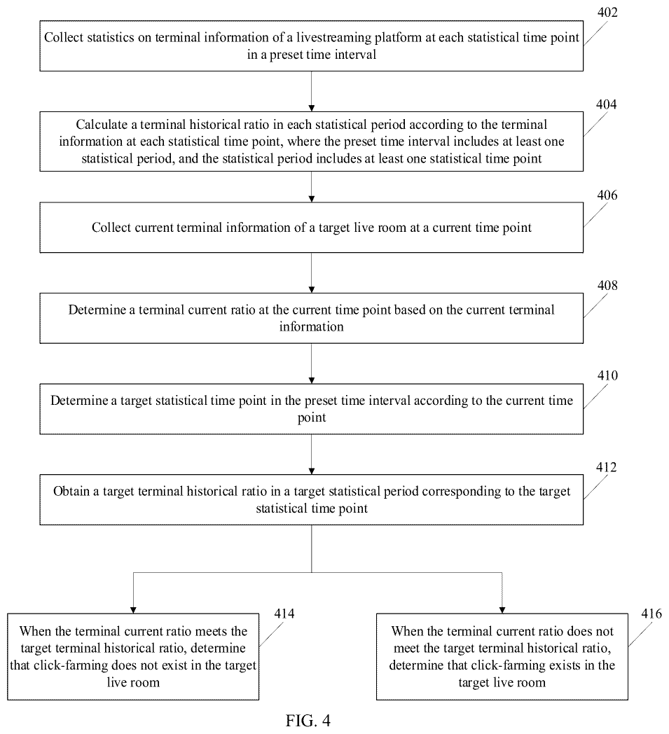

FIG. 4 is a schematic flowchart of a method for determining click-farming in a live room according to a third embodiment of this application. In the third embodiment, that a preset statistical time duration is combined with the historical terminal information to determine whether click-farming exists in the live room specifically includes the following steps.

Step 402: Collect statistics on terminal information of the livestreaming platform at each statistical time point in a preset time duration.

The step of collecting statistics on terminal information of the livestreaming platform at each statistical time point in a preset time duration specifically includes:
obtaining a user set of the livestreaming platform at each statistical time point in the preset time duration; and
determining terminal information of terminal devices used by users in each user set.

In the third embodiment provided in this application, the preset time duration is a predetermined time, for example, past 24 hours and past 48 hours. Terminal devices used by users in different time periods also vary. For example, a ratio of using mobile phone terminal devices is relatively high in daytime, and a ratio of using web terminal devices is relatively high in the evening. When it is close to the early morning, a ratio of mobile phone terminal devices increases again. Therefore, determining may be performed according to terminal information of each statistical time point in the preset time duration.

Specifically, the preset time duration usually includes at least one statistical period, and each statistical period includes a plurality of statistical time points. For example, the preset time duration is the past 24 hours, the past 24 hours are divided into 24 statistical periods in a unit of hour, and the terminal information is collected every 1 minute in each statistical period. The user set corresponding to each statistical time point is obtained, and statistics on the terminal information of the terminal devices used by the users in each user set is collected.

Step 404: Calculate a historical terminal ratio in each statistical period according to the terminal information at each statistical time point, where the preset time duration includes at least one statistical period, and the statistical period includes at least one statistical time point.

In the third embodiment provided in this application, the historical terminal ratio in each statistical period may be calculated according to the terminal information at each statistical time point. For example, in a statistical period of 9:00-10:00, the historical terminal ratio is that a mobile phone terminal percentage duration is “65%-85%”. In a statistical period of 19:00-20:00, the historical terminal ratio is that the mobile phone terminal percentage duration is “23%-48%”.

Step 406: Collect current terminal information of the target live room at a current time point.

In the third embodiment provided in this application, the current terminal information of the target live room at the current time point is collected. For example, the current time point is 19:20 in the evening. In this case, the current terminal information of the target live room at 19:20 is that there are a total of 336 users using mobile phones and 498 users using web terminal devices to view livestreaming in the target live room.

Step 408: Determine a current terminal ratio at the current time point based on the current terminal information.

In the third embodiment provided in this application, it is determined, according to 336 mobile phone terminal devices and 498 web terminal devices, that the current terminal ratio at the current time point is that mobile phone terminal percentage information is “40%”.

Step 410: Determine a target statistical time point in the preset time duration according to the current time point.

In the third embodiment provided in this application, it is determined, in the preset time duration according to a current time point 19:20, that the target statistical time point is 19:20.

Step 412: Obtain a target historical terminal ratio in a target statistical period corresponding to the target statistical time point.

In the third embodiment provided in this application, the target statistical period is determined as 19:00-20:00 according to the target statistical time point 19:20, and in the statistical period of 19:00-20:00, the target historical terminal ratio is that the mobile phone terminal percentage duration is “23%-48%”.

Step 414: When the current terminal ratio meets the target historical terminal ratio, determine that click-farming does not exist in the target live room.

In the third embodiment provided in this application, the current terminal ratio is that “the mobile phone terminal percentage information is 40%”, which meets the target historical terminal ratio being that “the mobile phone terminal percentage duration is 23%-48%”. Therefore, it can be determined that click-farming does not exist in the target live room.

Step 416: When the current terminal ratio does not meet the target historical terminal ratio, determine that click-farming exists in the target live room.

In the third embodiment provided in this application, if the current terminal ratio does not meet the target historical terminal ratio, it can be determined that click-farming exists in the target live room.

According to the method for determining click-farming in a live room provided in the third embodiment of this application, the historical terminal ratio in a past preset time duration is obtained, and then the current terminal information is compared with the historical terminal ratio in a past corresponding statistical period according to the current terminal information of the target live room at the current time point. Click-farming in the live room is comprehensively determined in a manner of combining the preset time duration with the terminal information, further enriching methods for determining whether click-farming exists in the live room, and improving accuracy of determining click-farming.

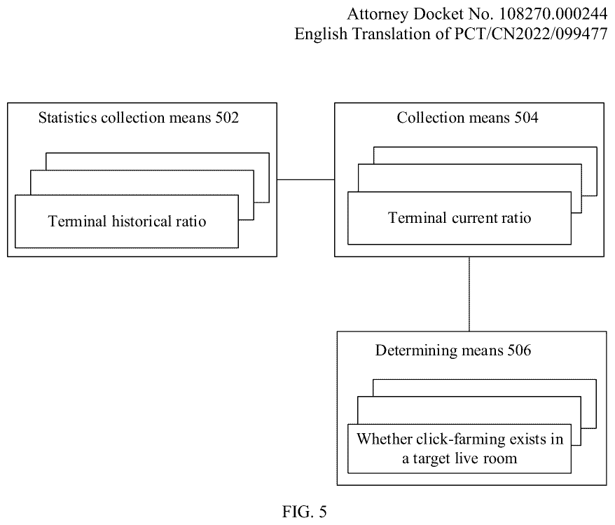

Corresponding to the foregoing embodiments of the method for determining click-farming in a live room, this application further provides an embodiment of an apparatus for determining click-farming in a live room. FIG. 5 is a schematic diagram of a structure of an apparatus for determining click-farming in a live room according to an embodiment of this application. As shown in FIG. 5, the apparatus includes:
a statistics collection means 502, configured to collect statistics on historical terminal information of a livestreaming platform, and determine a historical terminal ratio;
a collection means 504, configured to collect current terminal information of a target live room, and determine a current terminal ratio based on the current terminal information; and
a determining means 506, configured to determine, according to the historical terminal ratio and the current terminal ratio, whether click-farming exists in the target live room.

Optionally, the statistics collection means 502 is further configured to:
collect statistics on terminal information of the livestreaming platform at each statistical time point in a preset time duration; and
calculate a historical terminal ratio in each statistical period according to the terminal information at each statistical time point, where the preset time duration includes at least one statistical period, and the statistical period includes at least one statistical time point.

Optionally, the collection means 504 is further configured to:
collect current terminal information of the target live room at a current time point; and
determine a current terminal ratio at the current time point based on the current terminal information.

Optionally, the determining means 506 is further configured to:
determine a target statistical time point in the preset time duration according to the current time point;
obtain a target historical terminal ratio in a target statistical period corresponding to the target statistical time point; and
when the current terminal ratio meets the target historical terminal ratio, determine that click-farming does not exist in the target live room; or
when the current terminal ratio does not meet the target historical terminal ratio, determine that click-farming exists in the target live room.

Optionally, the statistics collection means 502 is further configured to:
obtain a user set of the livestreaming platform at each statistical time point in the preset time duration; and
determine terminal information of terminal devices used by users in each user set.

Optionally, the statistics collection means 502 is further configured to:
determine a live room type on the livestreaming platform;
collect statistics on historical terminal information corresponding to each live room type; and
calculate a historical terminal ratio corresponding to each live room type according to the historical terminal information corresponding to each live room type.

Optionally, the collection means 504 is further configured to:
determine a target live room type of the target live room and current terminal information corresponding to the target live room; and
calculate current terminal percentage information of the target live room according to the current terminal information.

Optionally, the determining means 506 is further configured to:
determine a target historical terminal ratio in the historical terminal ratio according to the target live room type; and
when the current terminal percentage information meets the target historical terminal ratio, determine that click-farming does not exist in the target live room; or
when the current terminal percentage information does not meet the target historical terminal ratio, determine that click-farming exists in the target live room.

Optionally, the statistics collection means 502 is further configured to:
obtain a user set corresponding to each live room type; and
determine terminal information of terminal devices used by users in each user set.

Optionally, the statistics collection means 502 is further configured to:
collect statistics on information about a terminal type participating in livestreaming on the livestreaming platform, and determine historical terminal type ratio information according to the terminal type information; and
collect statistics on terminal attribute information corresponding to each terminal type, and determine historical terminal attribute ratio information corresponding to each terminal type according to the terminal attribute information of each terminal type.

Optionally, the collection means 504 is further configured to:
collect the current terminal information of the target live room at the current time point; and
calculate current terminal type ratio information of the target live room and current terminal attribute ratio information corresponding to each terminal type according to the current terminal information.

Optionally, the determining means 506 is further configured to:
determine whether the current terminal type ratio information and the historical terminal type ratio information meet a type click-farming determining rule;
if yes, determine that click-farming exists in the target live room; or
if no, determine a target terminal type, and determine whether current terminal attribute ratio information corresponding to the target terminal type and historical terminal attribute ratio information corresponding to the target terminal type meet an attribute click-farming determining rule; and
if yes, determine that click-farming exists in the target live room; or
if no, determine that click-farming does not exist in the target live room.

Optionally, the statistics collection means 502 is further configured to:
obtain a set of users participating in livestreaming on the livestreaming platform; and
determine terminal type information of a terminal used by each user.

Optionally, the apparatus further includes:
a livestreaming user quantity obtaining means, configured to determine an initial live room on the livestreaming platform, and obtain a live room user quantity of the initial live room; and
a live room determining means 506, configured to: when the live room user quantity exceeds a preset threshold, determine the initial live room as a target live room.

The apparatus for determining click-farming in a live room provided in this embodiment of this application is configured to: collect statistics on historical terminal information of a livestreaming platform, and determine a historical terminal ratio; collect current terminal information of a target live room, and determine a current terminal ratio based on the current terminal information; and determine, according to the historical terminal ratio and the current terminal ratio, whether click-farming exists in the target live room. A comprehensive analysis manner of combining time and the live room type with terminal distribution is used to determine whether click-farming exists in the live room. An anti-click-farming policy of comprehensively determining the click-farming situation according to the historical terminal percentage information and the terminal percentage information at the current time point enriches methods for determining whether click-farming exists in the live room, and improves accuracy of determining click-farming.

The foregoing describes a schematic solution of the apparatus for determining click-farming in a live room in this embodiment. It should be noted that the technical solution of the apparatus for determining click-farming in a live room and the technical solution of the method for determining click-farming in a live room belong to a same concept. For details not described in detail in the technical solution of the apparatus for determining click-farming in a live room, refer to the descriptions of the technical solution of the method for determining click-farming in a live room.

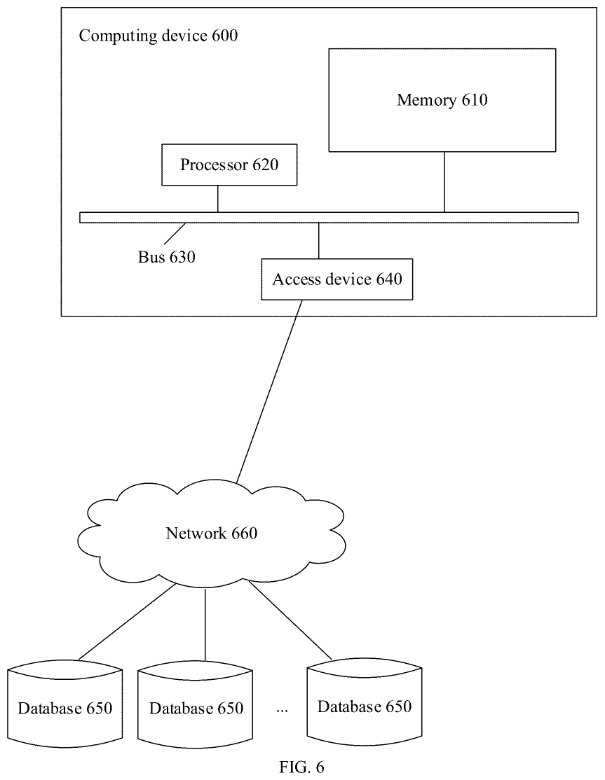

FIG. 6 is a block diagram of a structure of a computing device 600 according to an embodiment of this application. Components of the computing device 600 include but are not limited to a memory 610 and a processor 620. The processor 620 is connected to the memory 610 through a bus 630, and a database 650 is configured to store data.

The computing device 600 further includes an access device 640. The access device 640 enables the computing device 600 to perform communication by using one or more networks 660. Examples of these networks include a public switched telephone network (PSTN), a local area network (LAN), a wide area network (WAN), a private area network (PAN), or a combination of communication networks such as the Internet. The access device 640 may include one or more of any type of wired or wireless network interfaces (for example, a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In an embodiment of this application, the foregoing components of the computing device 600 and other components not shown in FIG. 6 may be connected to each other, for example, through a bus. It should be understood that the block diagram of the structure of the computing device shown in FIG. 6 is merely an example, and is not intended to limit the scope of this application. A person skilled in the art can add or replace other components as required.

The computing device 600 may be any type of stationary or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smartwatch or smart glasses), another type of mobile device, or a stationary computing device such as a desktop computer or a PC. The computing device 600 may alternatively be a mobile or stationary server.

The processor 620 implements the steps of the method for determining click-farming in a live room when executing computer instructions.

The foregoing describes a schematic solution of the computing device in this embodiment. It should be noted that the technical solution of the computing device and the technical solution of the method for determining click-farming in a live room belong to a same concept. For details not described in detail in the technical solution of the computing device, refer to the descriptions of the technical solution of the method for determining click-farming in a live room.

An embodiment of this application further provides a computer-readable storage medium, storing computer instructions, and the computer instructions are executed by a processor to implement the steps of the method for determining click-farming in a live room.

The foregoing describes a schematic solution of the computer-readable storage medium in this embodiment. It should be noted that the technical solution of the storage medium and the technical solution of the method for determining click-farming in a live room belong to a same concept. For details not described in detail in the technical solution of the storage medium, refer to the descriptions of the technical solution of the method for determining click-farming in a live room.

An embodiment of this application further provides a computer program, and when the computer program is executed in a computer, the computer is enabled to perform the steps of the method for determining click-farming in a live room.

The foregoing describes a schematic solution of the computer program in this embodiment of this application. It should be noted that the technical solution of the computer program and the technical solution of the method for determining click-farming in a live room belong to a same concept. For details not described in detail in the technical solution of the computer program, refer to the descriptions of the technical solution of the method for determining click-farming in a live room.

Specific embodiments of this application are described above. Other embodiments fall within the scope of the appended claims. In some cases, actions or steps described in the claims may be performed in an order different from that in the embodiments and desired results may still be achieved. In addition, processes described in the accompanying drawings do not necessarily require shown specific orders or sequences to achieve the desired results. In some implementations, multitasking and parallel processing are also possible or may be advantageous.

The computer instructions include computer program code, and the computer program code may be in a source code form, an object code form, an executable file form, some intermediate forms, or the like. The computer-readable medium may include: any entity or apparatus, a recording medium, a USB flash drive, a removable hard disk, a magnetic disk, a compact disc, a computer memory, a read-only memory (ROM), a random access memory (RAM), an electrical carrier signal, a telecommunication signal, a software distribution medium, and the like that are capable of carrying the computer program code. It should be noted that the content included in the computer-readable medium can be appropriately added or deleted depending on requirements of the legislation and patent practice in a jurisdiction. For example, in some jurisdictions, according to the legislation and patent practice, the computer-readable medium does not include an electrical carrier signal or a telecommunication signal.

It should be noted that, for brief description, the foregoing method embodiments are represented as a combination of a series of actions. However, a person skilled in the art should be aware that this application is not limited to the described order of the actions, because some steps may be performed in other orders or simultaneously according to this application. In addition, a person skilled in the art should also be aware that the embodiments described in this specification are all example embodiments, and used actions and means are not necessarily mandatory to this application.

In the foregoing embodiments, the descriptions of the embodiments have respective focuses. For a part that is not described in detail in a specific embodiment, refer to related descriptions in other embodiments.

The example embodiments of this application disclosed above are merely intended to help describe this application. In the optional embodiments, not all details are described in detail, and the present invention is not limited to only the specific implementations. Clearly, many modifications and variations may be made based on the content of this application. In this application, these embodiments are selected and specifically described to better explain the principle and actual application of this application, so that a person skilled in the art can well understand and use this application. This application is only subject to the claims and a full scope and equivalents thereof.

1. A method for determining click-farming in a live room, comprising:
collecting statistics on historical information about terminal devices which accessed a livestreaming platform;
determining a historical terminal ratio of different types of terminal devices based on the historical information;
collecting current information about terminal devices accessing a target live room at a current time point;
determining a current terminal ratio of different types of terminal devices at the current time point based on the current information; and
determining whether click-farming exists in the target live room based on the historical terminal ratio and the current terminal ratio.

2. The method according to claim 1, comprising:
collecting statistics on information about terminal devices which accessed the livestreaming platform at each statistical time point in a preset time duration; and
calculating a historical terminal ratio in each statistical period according to the information at each statistical time point, wherein the preset time duration comprises at least one statistical period, and each statistical period comprises at least one statistical time point.

3. (canceled)

4. The method according to claim 2, wherein the determining whether click-farming exists in the target live room based on the historical terminal ratio and the current terminal ratio comprises:
determining a target statistical time point in the preset time duration based on the current time point;
obtaining a target historical terminal ratio in a target statistical period corresponding to the target statistical time point;
determining that click-farming does not exist in the target live room when the current terminal ratio meets the target historical terminal ratio;
determining that click-farming exists in the target live room when the current terminal ratio does not meet the target historical terminal ratio.

5. The method according to claim 2, wherein the collecting statistics on information about terminal devices which accessed the livestreaming platform at each statistical time point in a preset time duration comprises:
obtaining information associated with a set of users of the livestreaming platform at each statistical time point in the preset time duration; and
determining information of terminal devices used by users in each set of users.

6. The method according to claim 1, further comprising:
determining types of live rooms on the livestreaming platform;
collecting statistics on historical information about terminal devices which accessed each type of live room; and
calculating a historical terminal ratio corresponding to each type of live room based on the historical information corresponding to each type of live room.

7. The method according to claim 6, wherein further comprising:
determining a target type of the target live room; and
calculating a current terminal percentage of the target live room based on the current information about the terminal devices accessing a target live room.

8. The method according to claim 7, further comprising:
determining a target historical terminal ratio according to the target type;
determining that click-farming does not exist in the target live room when the current terminal percentage meets the target historical terminal ratio; and
determining that click-farming exists in the target live room when the current terminal percentage does not meet the target historical terminal ratio.

9. (canceled)

10. The method according to claim 1, wherein the collecting statistics on historical information about terminal devices which accessed a livestreaming platform, and determining a historical terminal ratio comprises:
collecting statistics on attribute information of each type of terminal device; and
determining a historical attribute ratio corresponding to each type of terminal device based on the attribute information of each type of terminal device.

11. The method for determining click-farming in a live room according to claim 10, wherein the collecting current information about terminal devices accessing a target live room, and determining a current terminal ratio based on the current terminal information comprises:
a current attribute ratio corresponding to each type of terminal device based on the current information.

12. The method according to claim 11, wherein the determining whether click-farming exists in the target live room based on the historical terminal ratio and the current terminal ratio comprises:
determining whether the current terminal ratio and the historical terminal ratio meet a first rule;
determining that click-farming exists in the target live room in response to determining that the current terminal ratio and the historical terminal ratio meet the first;
in response to determining that the current terminal ratio and the historical terminal ratio do not meet the first rule, determining a target type of terminal device, and determining whether a current attribute ratio corresponding to the target type of terminal device and a historical attribute ratio corresponding to the target type of terminal device meet a second rule; and
determining that click-farming exists in the target live room in response to determining that the current attribute ratio corresponding to the target type of terminal device and the historical attribute ratio corresponding to the target type of terminal device meet the second rule;
determining that click-farming does not exist in the target live room in response to determining that the current attribute ratio corresponding to the target type of terminal device and the historical attribute ratio corresponding to the target type of terminal device do not meet the second rule.

13. (canceled)

14. The method according to claim 1, wherein before the collecting current information about terminal devices accessing a target live room, the method further comprises:
determining an initial live room on the livestreaming platform, and obtaining a quantity of users in the initial live room; and
identifying the initial live room as the target live room in response to determining that the quantity of users exceeds a preset threshold.

15. (canceled)

16. A computing device, comprising a memory, a processor, and computer instructions stored in the memory and executable by the processor, wherein the computer instructions upon execution by the processor cause the processor to implement operations comprising:
collecting statistics on historical information about terminal devices which accessed a livestreaming platform;
determining a historical terminal ratio of different types of terminal devices based on the historical information;
collecting current information about terminal devices accessing a target live room at a current time point;
determining a current terminal ratio of different types of terminal devices at the current time point based on the current information; and
determining whether click-farming exists in the target live room based on the historical terminal ratio and the current terminal ratio.

17. A non-transitory computer-readable storage medium, storing computer instructions, wherein the computer instructions, when executed by a processor, cause the processor to implement operations comprising:
collecting statistics on historical information about terminal devices which accessed a livestreaming platform;
determining a historical terminal ratio of different types of terminal devices based on the historical information;
collecting current information about terminal devices accessing a target live room at a current time point;
determining a current terminal ratio of different types of terminal devices at the current time point based on the current information; and
determining whether click-farming exists in the target live room based on the historical terminal ratio and the current terminal ratio.

18. (canceled)

19. The computing device according to claim 16, the operations further comprising:
collecting statistics on information about terminal devices which accessed the livestreaming platform at each statistical time point in a preset time duration; and
calculating a historical terminal ratio in each statistical period according to the information at each statistical time point, wherein the preset time duration comprises at least one statistical period, and each statistical period comprises at least one statistical time point.

20. The computing device according to claim 19, the operations further comprising:
determining a target statistical time point in the preset time duration based on the current time point;
obtaining a target historical terminal ratio in a target statistical period corresponding to the target statistical time point;
determining that click-farming does not exist in the target live room when the current terminal ratio meets the target historical terminal ratio; and
determining that click-farming exists in the target live room when the current terminal ratio does not meet the target historical terminal ratio.

21. The computing device according to claim 16, the operations further comprising:
determining types of live rooms on the livestreaming platform;
collecting statistics on historical information about terminal devices which accessed each type of live room; and
calculating a historical terminal ratio corresponding to each type of live room based on the historical information corresponding to each type of live room.

22. The computing device according to claim 21, the operations further comprising:
determining a target type of the target live room;
calculating a current terminal percentage of the target live room based on the current information about the terminal devices accessing a target live room;
determining a target historical terminal ratio according to the target type;
determining that click-farming does not exist in the target live room when the current terminal percentage meets the target historical terminal ratio; and
determining that click-farming exists in the target live room when the current terminal percentage does not meet the target historical terminal ratio.

23. The computing device according to claim 16, the operations further comprising:
collecting statistics on historical attribute information of each type of terminal device accessed which accessed the livestreaming platform;
determining a historical attribute ratio corresponding to each type of terminal device based on the historical attribute information of each type of terminal device; and
calculating a current attribute ratio corresponding to each type of terminal device based on the current information.

24. The computing device according to claim 23, wherein the determining whether click-farming exists in the target live room based on the historical terminal ratio and the current terminal ratio comprises:
determining whether the current terminal ratio and the historical terminal ratio meet a first rule;
determining that click-farming exists in the target live room in response to determining that the current terminal ratio and the historical terminal ratio meet the first;
in response to determining that the current terminal ratio and the historical terminal ratio do not meet the first rule, determining a target type of terminal device and determining whether a current attribute ratio corresponding to the target type of terminal device and a historical attribute ratio corresponding to the target type of terminal device meet a second rule; and
determining that click-farming exists in the target live room in response to determining that the current attribute ratio corresponding to the target type of terminal device and the historical attribute ratio corresponding to the target type of terminal device meet the second rule;
determining that click-farming does not exist in the target live room in response to determining that the current attribute ratio corresponding to the target type of terminal device and the historical attribute ratio corresponding to the target type of terminal device do not meet the second.

25. The non-transitory computer-readable storage medium according to claim 17, the operations further comprising:
collecting statistics on information about terminal devices which accessed the livestreaming platform at each statistical time point in a preset time duration; and
calculating a historical terminal ratio in each statistical period according to the information at each statistical time point, wherein the preset time duration comprises at least one statistical period, and each statistical period comprises at least one statistical time point.
